(19) United States
(12) Patent Application Publication
(10) Pub. No.: US 2003/0083021 A1
(43) Pub. Date: May 1, 2003

(54) Keypad assembly

(76) Inventors: Che-Yuan Hsu, Tu-Chen (TW); GeNing Dong, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/094,697

(22) Filed: Mar. 8, 2002

(30) Foreign Application Priority Data
Oct. 26, 2001 (TW) 90218390

(51) Int. Cl. H04B 1/00

(52) U.S. Cl. 455/90; 455/575

(57) ABSTRACT

A keypad assembly comprises a keypad (1), a rubber plate (3), and an intermediate plate (2) interposed between the keypad and the rubber plate. The intermediate plate includes a base sheet (20), and a plurality of apertures (22) defined in the base sheet. Each aperture has a shape corresponding to a periphery of a leg portion (12) of a corresponding key (10) of the keypad. When pressure is applied on a key, the key travels downwardly and contacts the rubber plate through the corresponding aperture of the intermediate plate, and the rubber plate transmits the pressure to a switch assembly. When the pressure on the key is released, resilient force of the rubber plate causes the rubber plate and the key to return to their original positions.

### BACKGROUND OF THE INVENTION

1. Field of the Invention

The present invention relates to a keypad assembly, and particularly to a keypad assembly for use in a mobile phone.

2. Related Art

Keypad assemblies are widely used in electronic devices such as calculators, computers and mobile phones. Keypad assemblies function as interface means for users to input information into the electronic devices. A conventional keypad assembly comprises a keypad having a plurality of keys, and a rubber plate directly mounted to an underside of the keypad. A switch assembly is located under and engages with the rubber plate. The switch assembly functions to activate switching circuits on a printed circuit board. The keypad assembly is secured under a front cover of a corresponding electronic device. Each key has an exposed portion projecting upwardly from the cover, for pressing by a user. When the pressing force acting on the key is released, the rubber plate exerts resilient force on the key to return the key to its original position. Conventionally, each key also has a flange around a periphery of the exposed portion, for engaging with an underside of the cover. The flange prevents the key from escaping from the electronic device when the key returns to its original position.

The trend toward miniaturization of electronic devices requires that space in an electronic device for accommodating a keypad assembly must be absolutely minimal. Nowadays, such space frequently does not allow a keypad assembly to provide a flange on each key. Therefore, an improved keypad assembly which overcomes the abovementioned problems is strongly desired.

### BRIEF SUMMARY OF THE INVENTION

An object of the present invention is to provide a keypad assembly for a portable electronic device, the keypad assembly having keys which are compactly and reliably secured in the portable electronic device.

To achieve the above object, the present invention provides a keypad assembly which comprises a keypad, a rubber plate and an intermediate plate interposed between the keypad and the rubber plate. The intermediate plate includes a base sheet, and a plurality of apertures defined in the base sheet. Each aperture has a shape corresponding to a periphery of a leg portion of a corresponding key of the keypad. When pressure is applied on a key, the key travels downwardly and contacts the rubber plate through the corresponding aperture of the intermediate plate, and the rubber plate transmits the pressure to a switch assembly. When the pressure on the key is released, resilient force of the rubber plate causes the rubber plate and the key to return to their original positions.

For a better understanding of the present invention, including practice of the invention, reference is now be made by way of example only to the appended drawings in which:

### BRIEF DESCRIPTION OF THE DRAWINGS

FIG. 1 is an exploded view of a keypad assembly of the present invention;

FIG. 2 is an enlarged view of an intermediate plate of the keypad assembly of FIG. 1;

FIG. 3 is similar to FIG. 1, but viewed from another aspect;

FIG. 4 is similar to FIG. 1, but showing the intermediate plate attached to a rubber plate of the keypad assembly; and

FIG. 5 is an assembled view of FIG. 1, with part of the rubber plate cut away for better illustration.

### DESCRIPTION OF THE PREFERRED EMBODIMENT

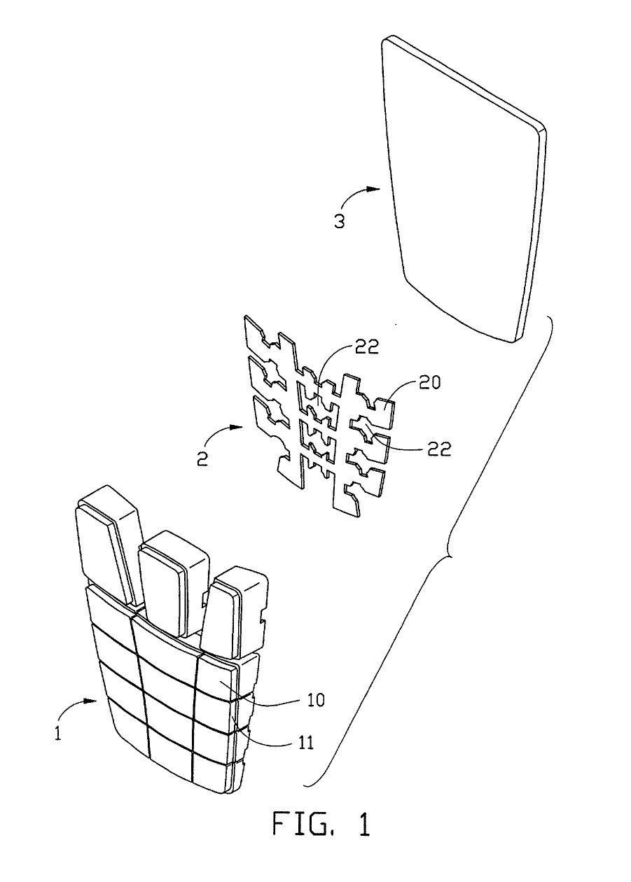

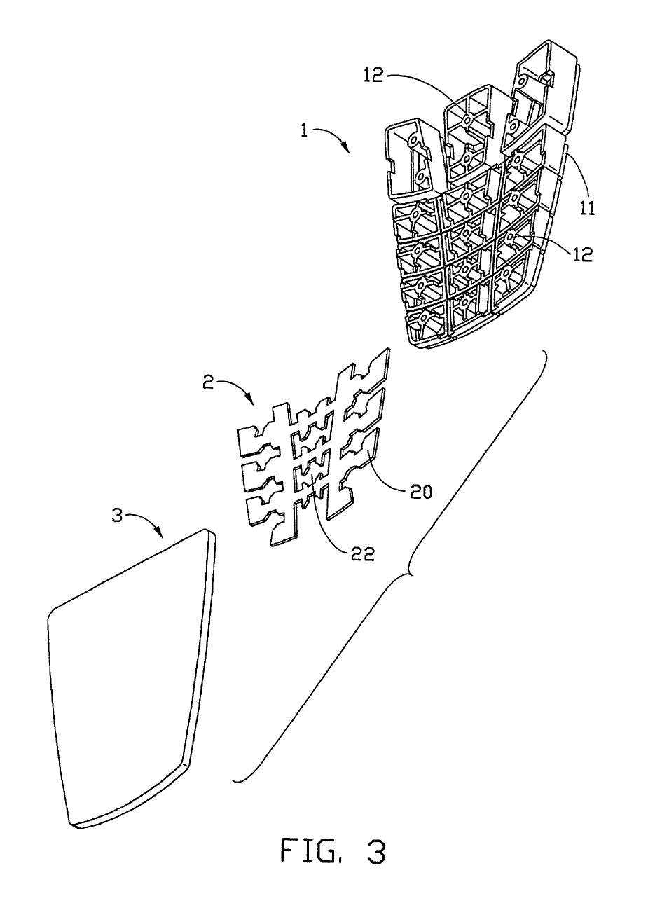

Referring to FIGS. 1 and 3, a keypad assembly in accordance with a preferred embodiment of the present invention comprises a keypad 1, a rubber plate 3, and an intermediate plate 2 interposed between the keypad 1 and the rubber plate 3. The keypad assembly is for use in a mobile phone.

The keypad 1 includes a plurality of keys 10. Each key 10 has an upper portion 11 for receiving a pressing force from a user, and a leg portion 12 around the center portion thereof for supporting the key 10 on the rubber plate 3 and for activating a switch assembly (not shown). The rubber plate 3 is elastic so that it can provide a sufficient resilient force to return any key 10 to its original position after a pressing force acting on that key 10 is released.

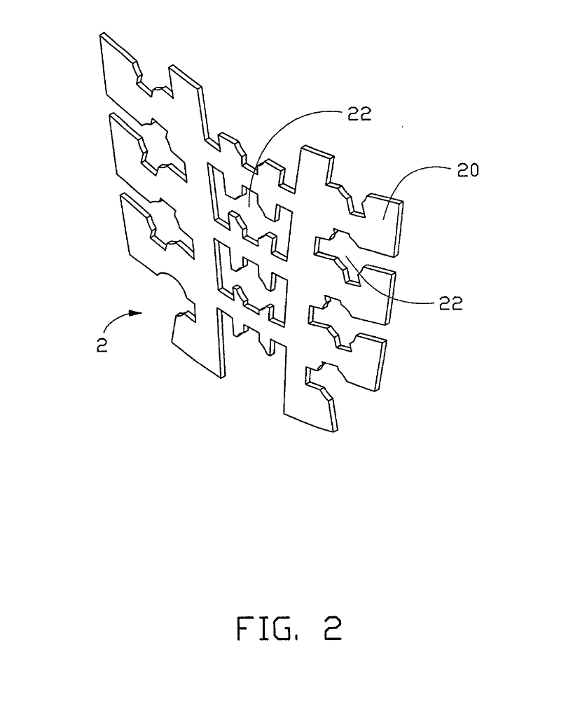

Referring to FIG. 2, the intermediate plate 2 is constructed from a relatively rigid plastic material such as transparent polyvinyl chloride (PVC). The intermediate plate 2 may be formed by any suitable process such as plastic injection molding. The intermediate plate 2 includes a base sheet 20, and a plurality of apertures 22 defined in the base sheet 20. Each aperture 22 has a shape corresponding to a periphery of the leg portion 12 of a corresponding key 10. Therefore the leg portion 12 of the corresponding key 10 extends through the aperture 22 to engage with the rubber plate 3 without improperly interfering with the intermediate plate 2.

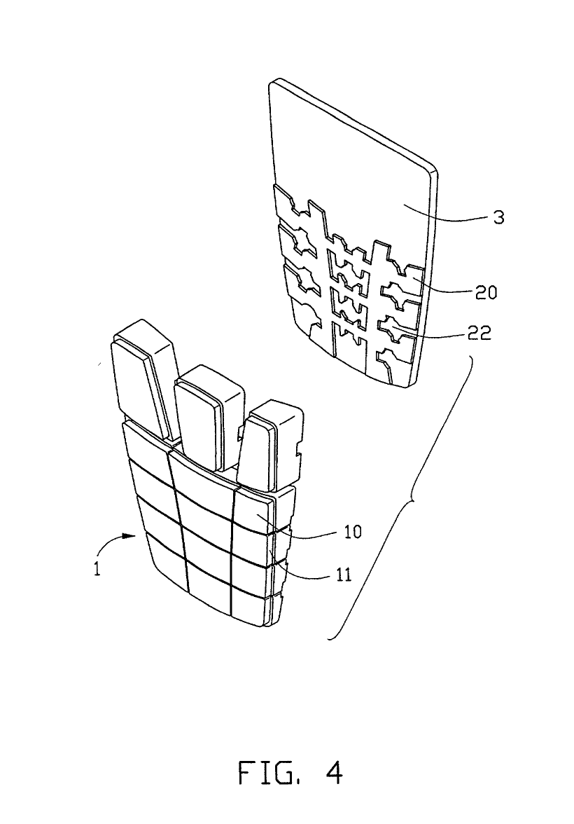

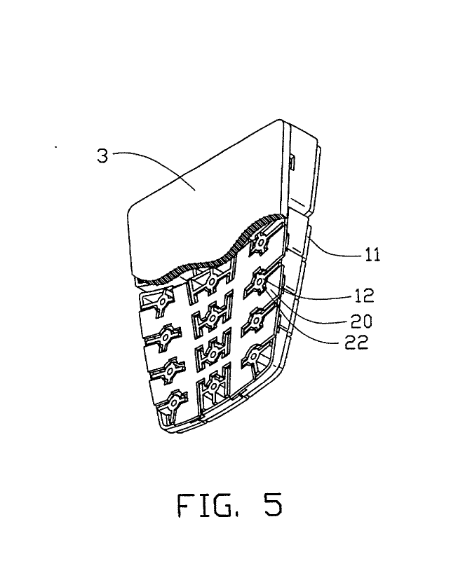

Referring to FIGS. 4 and 5, in assembly, the intermediate plate 2 is firstly glued to the rubber plate 3. The keypad 1 is glued to the rubber plate 2, with the leg portions 12 of the keys 10 respectively extending through the apertures 22 of the intermediate plate 2 to establish connection with the rubber plate 3 while the corner portions (not labeled) of the keys 10 are substantially located above the intermediate plate 2.

In operation, when the user presses the upper portion 11 of one of the keys 10, the pressed key 10 travels downwardly so that the leg portion 12 thereof presses a corresponding portion of the rubber plate 3. The rubber plate 3 in turn depresses a key dome (not shown) of a switch assembly (not shown), to activate a switch circuit (not shown) on a printed circuit board (not shown). When the pressing force on the key 10 is released, the resilient force of the rubber plate 3 causes the rubber plate 3 and the key 10 to return to their original positions. Thus, the key dome resumes its original shape and the activated switch circuit is inactivated.

In the present invention, the intermediate plate 2 glued to the rubber plate 3 reinforces the rubber plate 3. This minimizes the risk of buckling of the rubber plate 3 due to pressing force received from pressed keys 10. In addition, the apertures 22 of the intermediate plate 2 function guides to ensure that the leg portions 12 of the keys 10 accurately depress corresponding portions of the rubber plate 3. Furthermore, the keys 10 do not need flanges in order to be secured under a front cover of a mobile phone. Therefore, the keypad assembly of the present invention can be used in a mobile phone which has limited space for accommodating a keypad assembly.

Although the preferred embodiment of the present invention has been described in connection with use in a mobile phone, a person skilled in the art can easily recognize that the keypad assembly described herein may be used in various other kinds of portable electronic apparatuses that require a keypad for data entry.

Furthermore, it is to be understood that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms in which the appended claims are expressed.

We claim:

1. A keypad assembly for use in an electronic apparatus, comprising:
a rubber plate;
an intermediate plate secured to the rubber plate and defining a plurality of apertures therein; and
a keypad comprising a plurality of keys, each of the keys having an upper portion adapted for receiving a pressing force acting thereon to enter data into the electronic apparatus, and further having a leg portion extending through a corresponding aperture of the intermediate plate to engage with the rubber plate.

2. The keypad assembly as claimed in claim 1, wherein the intermediate plate is made of plastic material.

3. The keypad assembly as claimed in claim 2, wherein the plastic material is transparent.

4. The keypad assembly as claimed in claim 3, wherein the intermediate plate is made of transparent polyvinyl chloride.

5. The keypad assembly as claimed in claim 1, wherein the intermediate plate is glued to the rubber plate, and the keypad is also glued to the rubber plate.

6. The keypad assembly as claimed in claim 1, wherein each of the leg portions of the keys has a configuration corresponding to a configuration of a corresponding aperture of the intermediate plate.

7. A keypad assembly comprising:
a rubber plate;
a keypad comprising a plurality of keys, each of said keys adapted to be up and down moved and having an upper portion adapted for receiving a pressing force imposed thereon, and a leg portion downwardly extending from the upper portion with thereof a bottom end in contact with said rubber plate; and
an intermediate plate positioned between said rubber plate and said keypad, said intermediate plate being stiffer than said rubber plate and defining a plurality of apertures which the legs of the keys are able to extend through respectively to engage the rubber plate; wherein
when operated, the leg portions are compliantly received within the corresponding apertures for guidably upward and down moved relative to said intermediate plate.

8. The assembly as claimed in claim 7, wherein said leg portion is attached to the rubber plate.

9. The assembly as claimed in claim 7, wherein said intermediate plate is attached to said rubber plate.

10. The assembly as claimed in claim 7, said leg portions defining configurations different those of the corresponding upper portions.

11. The assembly as claimed in claim 7, wherein said apertures are configured to respectively comply with the corresponding leg portions of the keys rather than with the upper portions of the keys

12. The assembly as claimed in claim 7, wherein said leg portions include portions of a cross-like configuration to achieve better guidance in the corresponding apertures.

13. In combination, a soft rubber plate with a switch assembly thereunder, an intermediate plate, which is stiffer than the rubber plate, attached unto the rubber plate with a plurality of apertures therein, and a keypad including a plurality of discrete keys each including a leg portion around a bottom center portion, said leg portion extending below corresponding bottom corner portions of said key and further through the corresponding aperture to be attached to the rubber plate; wherein said key is up and down moveable relative to the intermediate plate with the leg portion thereof is received in the corresponding aperture while the corresponding bottom comer portions thereof are located above the intermediate plate.

14. The combination as described in claim 13, wherein said apertures are compliantly configured to be similar to the leg portions of the corresponding keys, respectively, for guidance of up-and-down movement of said leg portions therein.
